(19) United States
(12) Patent Application Publication
(10) Pub. No.: US 2014/0069856 A1
(43) Pub. Date: Mar. 13, 2014

(54) WATER GATHERING COVER

(71) Applicant: Ying-Chen LIN, Hsinchu (TW)

(72) Inventor: Ying-Chen LIN, Hsinchu (TW)

(21) Appl. No.: 13/613,105

(22) Filed: Sep. 13, 2012

(51) Int. Cl. B01D 35/30; B01D 27/00

(52) U.S. Cl. 210/232

(57) ABSTRACT

A water gathering cover has a water gathering element, multiple hole sets and multiple mounting sleeves. Because a cover of a water purification unit and the water gathering element are integrated, the assembling of the water purification device is simplified as follows. A filter cartridge of the water purification unit is mounted in one of the hole sets after being aligned with the hole set. A casing of the water purification unit is mounted around the filter cartridge and is mounted securely to a corresponding mounting sleeve. Then the assembling of the water purification device is completed. As a result, the water gathering cover comprises fewer components, which simplifies the assembling of the water purification device and lowers the cost. Besides, the assembling of the water purification device only needs one round of aligning process.

### BACKGROUND OF THE INVENTION

1. Field of the Invention

The present invention relates to a water gathering cover, especially to a water gathering cover that is for filter cartridge in a water purification device.

2. Description of the Prior Arts

A conventional water purification device, such as ultrapure water machine or water filter, comprises a water gathering element and multiple water purification units. Each water purification unit comprises a cover, a casing and a filter cartridge. The type of the filter cartridge is not limited, and the filter cartridge may be polypropylene (PP) filter cartridge, activated carbon filter cartridge, hollow fiber filter cartridge, purified resin filter cartridge, ceramics filter cartridge, reverse osmosis (RO) filter cartridge and so on.

When the water purification device is to be assembled, the water purification units are assembled first. The filter cartridge is mounted in the cover. The inlet tube or outlet tube of the filter cartridge protrudes out of the top surface of the cover after being aligned with the cover. Then the casing is mounted on the cover, and the casing and the cover wrap around the filter cartridge. The casing and the cover are connected securely by threads or ultrasonic welding. Finally, the assembled water purification units are mounted on the water gathering element. The inlet tube or outlet tube protruding out of the top surface of the cover is mounted in the water gathering element after being aligned with the water gathering element. Then the cover and water gathering element are connected securely by screws. Each water purification unit is mounted on the water gathering element by the same means. Then the assembling of the water purification device is completed.

For the water purification device in use, the water gathering element has a main inlet, a main outlet and multiple inner channels. The inner channels are connected with each other in series connection, parallel connection or series connection plus parallel connection. The water enters the water gathering element from the main inlet, and then enters the corresponding filter cartridge(s) through the inner channels. After being purified by the filter cartridge, the water flows out of the water gathering element through the inner channels and from the main outlet. The water out of the main outlet is purified and can be used.

However, as described above, the water purification device comprises a water gathering element and multiple water purification units, and each water purification unit comprises a cover, a casing and a filter cartridge. The water purification device comprises so many components, and the whole assembling process is complicated. When the number of the water purification unit reaches three, four or even more, the combination and aligning is tedious and the manufacturing cost is high.

To overcome the shortcomings, the present invention provides a water gathering cover to mitigate or obviate the aforementioned problems.

### SUMMARY OF THE INVENTION

The main objective of the present invention is to provide a water gathering cover that comprises reduced number of components and is easily assembled.

The water gathering cover in accordance with the present invention has a water gathering element, multiple hole sets and multiple mounting sleeves. Because a cover of a water purification unit and the water gathering element are integrated, the assembling of the water purification device is faster and more convenient as follows. A filter cartridge of the water purification unit is first aligned with and then mounted in one of the hole sets. A casing of the water purification unit is mounted around the filter cartridge and is mounted securely to a corresponding mounting sleeve. Then the assembling of the water purification device is completed. As a result, the water gathering cover comprises fewer components, which simplifies the assembling of the water purification device and lowers the cost. Besides, the assembling of the water purification device only needs one round of aligning process, so the assembling is easier and faster.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a water gathering cover in accordance with the present invention;

FIG. 2 is another perspective view of the water gathering cover in FIG. 1;

FIG. 3 is a bottom view of the water gathering cover in FIG. 1;

FIG. 4 is a side view in partial section of the water gathering cover in FIG. 1;

FIG. 5 is a top view in partial section of the water gathering cover in FIG. 1, showing the inner channels;

FIG. 6 is an operational view of the water gathering cover in FIG. 1, showing the combination with the water purification unit;

FIG. 7 is a top view in partial section of a second embodiment of the water gathering cover in accordance with the present invention, showing the inner channels;

FIG. 8 is a bottom view of a third embodiment of the water gathering cover in accordance with the present invention;

FIG. 9 is a top view in partial section of the water gathering cover in FIG. 8, showing the inner channels;

FIG. 10 is a bottom view of a fourth embodiment of the water gathering cover in accordance with the present invention;

FIG. 11 is a top view in partial section of the water gathering cover in FIG. 10, showing the inner channels;

FIG. 12 is a bottom view of a fifth embodiment of the water gathering cover in accordance with the present invention; and

FIG. 13 is a top view in partial section of the water gathering cover in FIG. 12, showing the inner channels.

### DETAILED DESCRIPTION OF THE PREFERRED EMBODIMENTS

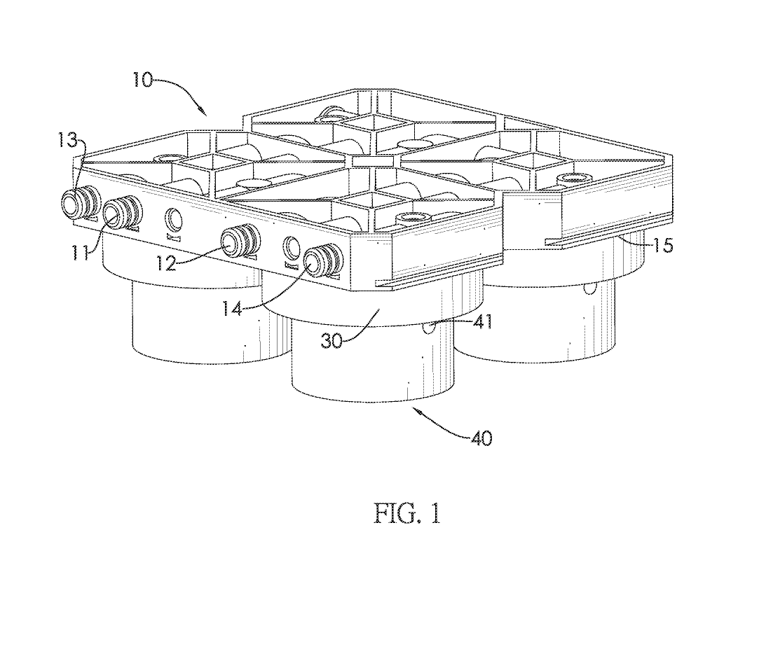

With reference to FIGS. 1, 2 and 5, a first embodiment of a water gathering cover in accordance with the present invention comprises a water gathering element 10, four hole sets 20 and four mounting sleeves 30. In a preferred embodiment, the water gathering cover further comprises four separating sleeves 40.

The water gathering element 10 has a mounting surface 15, a main inlet 11, a main purifying outlet 12 and multiple inner channels 16. In a preferred embodiment, the water gathering element 10 is substantially square, and the mounting surface 15 is a bottom surface of the water gathering element 10. The water gathering element 10 further has two main waste outlets 13, 14. The main inlet 11, the main purifying outlet 12 and the main waste outlets 13, 14 are formed on a same side of the water gathering element 10.

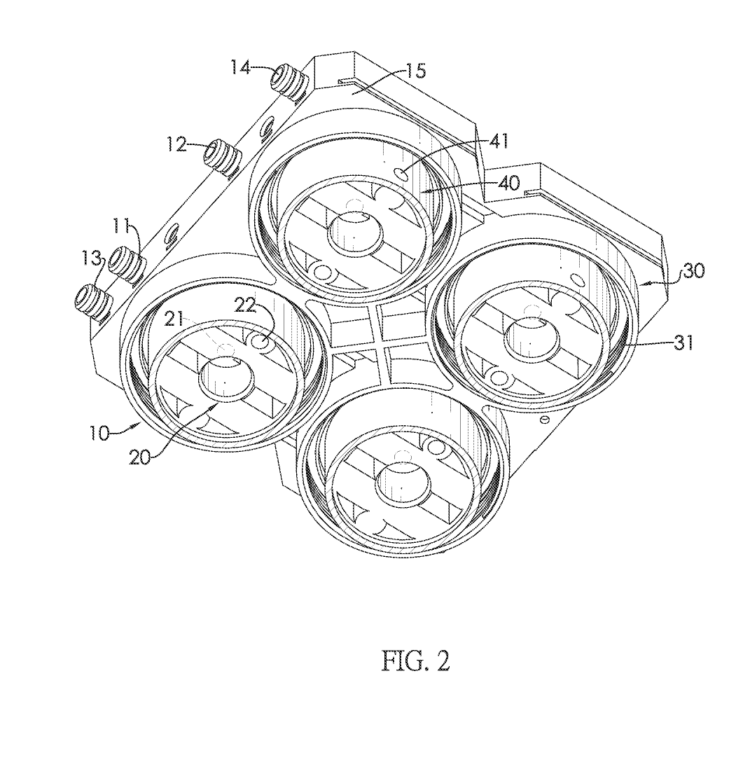

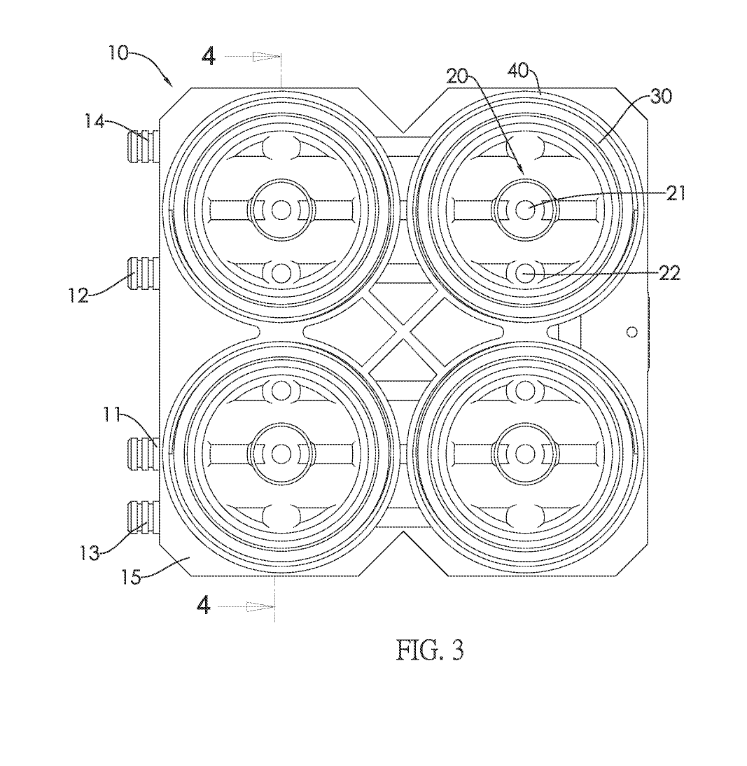

With reference to FIGS. 2 to 5, the hole sets 20 are formed on the mounting surface 15 of the water gathering element 10. Two of the hole sets 20 are respectively communicating with the main inlet 11 and the main purifying outlet 12 through one of the inner channels 16. The hole sets 20 communicate with each other through the inner channels 16. Each hole set 20 has an inlet 21 and a purifying outlet 22. In a preferred embodiment, each hole set 20 further has a waste outlet 23. The waste outlet 23 of each hole set 20 communicates with one of the main waste outlets 13, 14 through one of the inner channels 16. The four hole sets 20 are arranged in a rectangle.

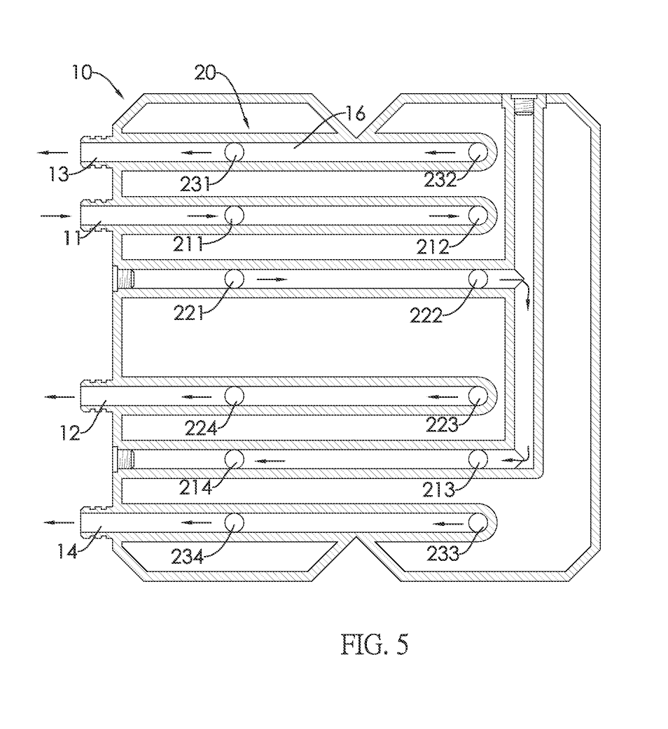

With reference to FIG. 5, the four hole sets 20 are a first hole set 20, a second hole set 20, a third hole set 20 and a fourth hole set 20 respectively.

The first hole set 20 and the second hole set 20 are in parallel connection. The inlets 211, 212 of the first and second hole sets 20 communicate with the main inlet 11 of the water gathering element 10 through one of the inner channels 16. The purifying outlets 221, 222 of the first and second hole sets 20 communicate with each other through one of the inner channels 16. The waste outlets 231, 232 of the first and second hole sets 20 communicate with one of the main waste outlets 13 of the water gathering element 10 through one of the inner channels 16.

The third hole set 20 and the fourth hole set 20 are in parallel connection. The inlets 213, 214 of the third and fourth hole sets 20 communicate with each other through one of the inner channels 16. The purifying outlets 223, 224 of the third and fourth hole sets 20 communicate with the main purifying outlet 12 of the water gathering element 10 by one of the inner channels 16. The waste outlets 233, 234 of the third and fourth hole sets 20 communicate with one of the main waste outlets 14 of the water gathering element 10 through one of the inner channels 16.

The combination of the first and second hole sets 20 is in series connection with the combination of the third and fourth hole sets 20. The inlets 213, 214 of third and fourth the hole sets 20 communicate with the purifying outlets 221, 222 of the first and second hole sets 20 by one of the inner channels 16.

With reference to FIGS. 1, 2 and 4, the four mounting sleeves 30 are formed on the mounting surface 15 of the water gathering element 10, and respectively surround the four hole sets 20. In a preferred embodiment, each mounting sleeve 30 has an inner thread 31 formed on an inside wall of the mounting sleeve 30.

The four separating sleeves 40 are formed on the mounting surface 15 of the water gathering element 10, respectively surround the four hole sets 20, and are respectively surrounded by the four mounting sleeve 30. Each separating sleeves 40 has a separating hole 41. The separating hole 41 is formed through the separating sleeve 40 and communicates with the waste outlet 23 of a corresponding hole set 20.

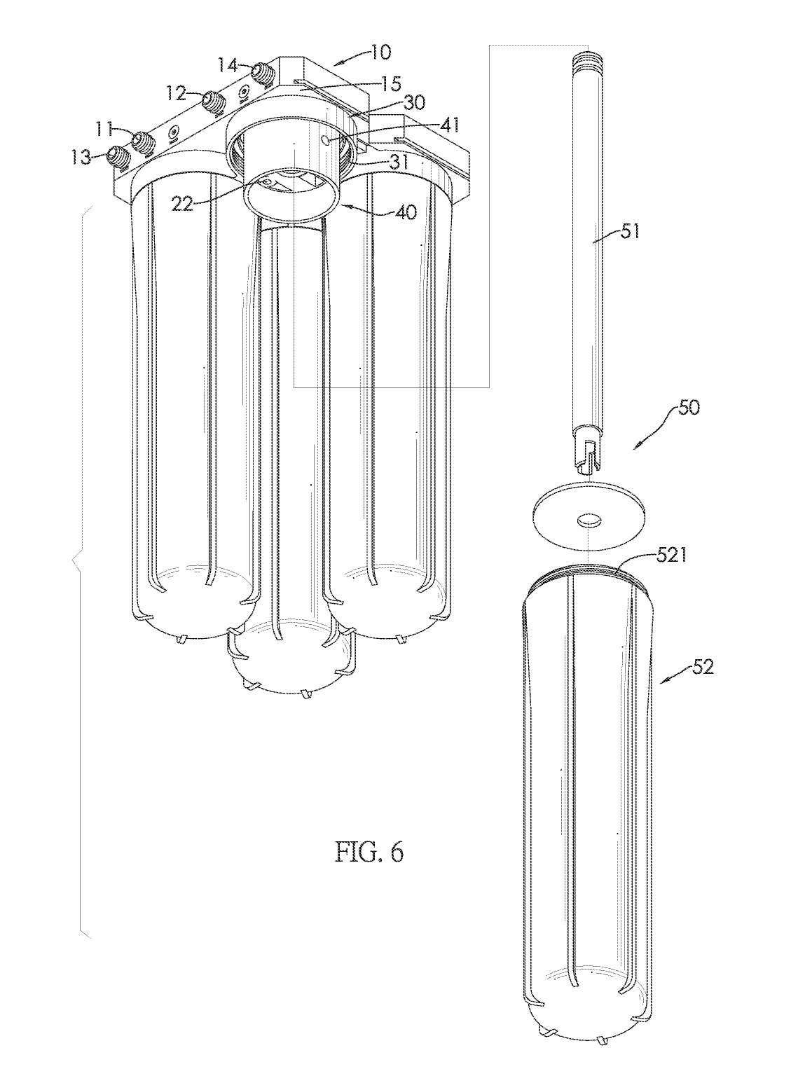

With reference to FIGS. 2, 4 and 6, the water gathering cover can be installed with four water purification units 50. Each water purification unit 50 has a filter cartridge 51 and a casing 52. The filter cartridge 51 may be polypropylene (PP) filter cartridge, activated carbon filter cartridge, hollow fiber filter cartridge, purified resin filter cartridge, ceramics filter cartridge, reverse osmosis (RO) filter cartridge and so on. The casing 52 has an inner space and a top opening The casing 52 further has an outer thread 521 formed on an outside wall of the casing 52 and formed adjacent to the top opening When the water purification unit 50 is installed on the water gathering cover, the filter cartridge 51 is mounted in one of the hole sets 20 after being aligned with the hole set 20. The casing 52 is mounted around the filter cartridge 52 and is screwed into a corresponding mounting sleeve 30. Each water purification unit 50 is mounted on the water gathering element 10 by the same means. Then the assembling of the water purification device is completed. As a result, the water gathering cover comprises fewer components, which simplifies the assembling of the water purification device and lowers the cost. Besides, the assembling of the water purification device only needs one round of aligning process, so the assembling is easier and faster.

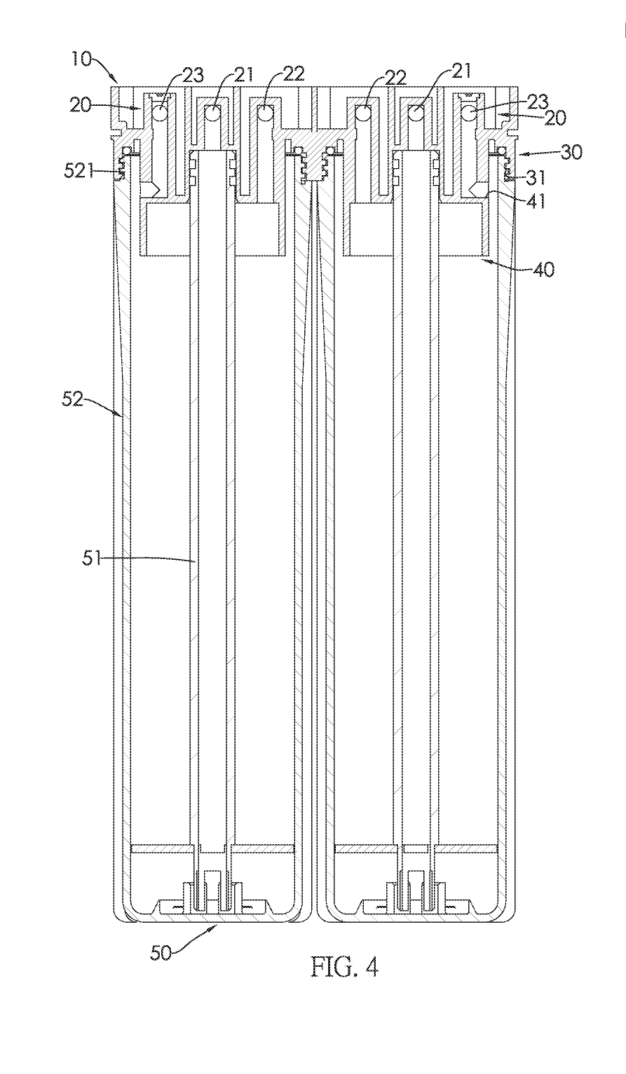

With reference to FIGS. 4 and 5, when the water purification device is used, the water enters the water gathering element 10 from the main inlet 11, and then is divided into two flows by the two inlets 211, 212. The two flows of the water respectively enter two of the filter cartridges 51. After being purified by the filter cartridge 51, each flow of the water is further divided into purified water and waste water. The waste water from the two filter cartridges 51 respectively flows back to the water gathering element 10 by going through the corresponding separating hole 41 of the separating sleeve 40 and the corresponding waste outlet 231, 232. Then the waste water is gathered and flows out from one of the main waste outlets 13 through one of the inner channels 16. The purified water from the two filter cartridges 51 respectively flows back to the water gathering element 10 by going through the corresponding purifying outlet 221, 222. Then the purified water is gathered and flows to the other two hole sets 20 together. The gathered purified water is divided into two flows by the two inlets 213, 214. In the same way, the two flows of the water respectively enter two of the filter cartridges 51. After being purified by the filter cartridge 51, the waste water respectively flows back to the water gathering element 10 from the corresponding separating hole 41 and the corresponding waste outlets 233, 234. Then the waste water is gathered and flows out from one of the main waste outlets 14 by one of the inner channels 16. The purified water from the two filter cartridges 51 respectively flows back to the water gathering element 10 from the corresponding purifying outlets 223, 224. Then the purified water is gathered and flows out from the main purifying outlet 12 by one of the inner channels 16. The water that finally flows out is purified twice by two filter cartridges 51.

The above description shows that more water can be purified at the same time if more hole sets 20 with the filter cartridges 51 are in parallel connection. Besides, the water can be purified for more times if more hole sets 20 with the filter cartridges 51 are in series connection.

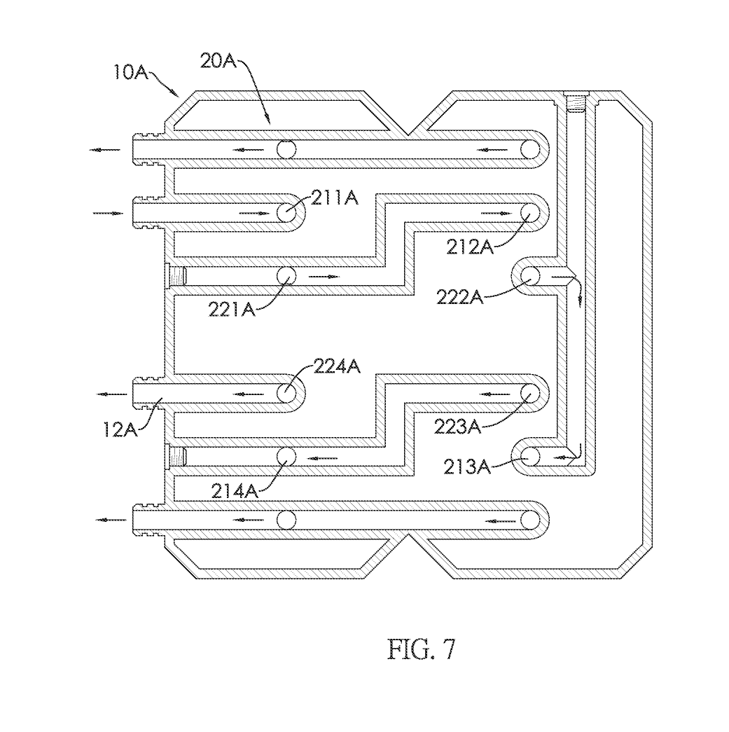

With reference to FIG. 7, a second embodiment of a water gathering cover in accordance with the present invention is similar to the first embodiment as described above. However, in the second embodiment, the four hole sets 20A are in series connection. The water flows in and out of the first filter cartridge from the inlet 211A and the purifying outlet 221A of the first hole set 20A respectively. Then the water flows in and out of the second filter cartridge from the inlet 212A and the purifying outlet 222A of the second hole set 20A respectively. Then the water flows in and out of the third filter cartridge from the inlet 213A and the purifying outlet 223A of the third hole set 20A respectively. Then the water flows in and out of the fourth filter cartridge from the inlet 214A and the purifying outlet 224A of the fourth hole set 20A respectively. Finally the water flows out of the water gathering element 10A form the main purifying outlet 12A, and the water that flows out is purified for four times. The second embodiment can reach the same goal of reduced components and simplified assembling.

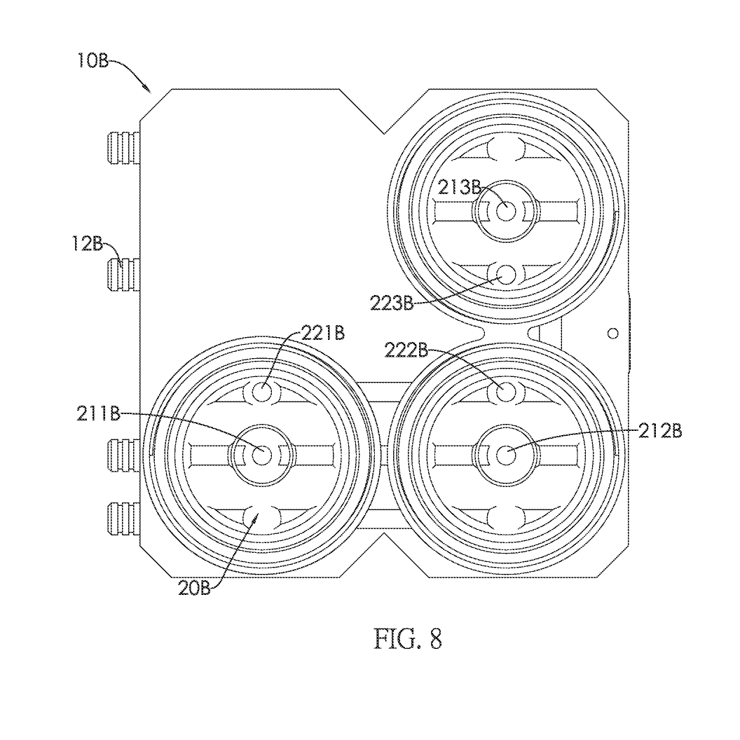

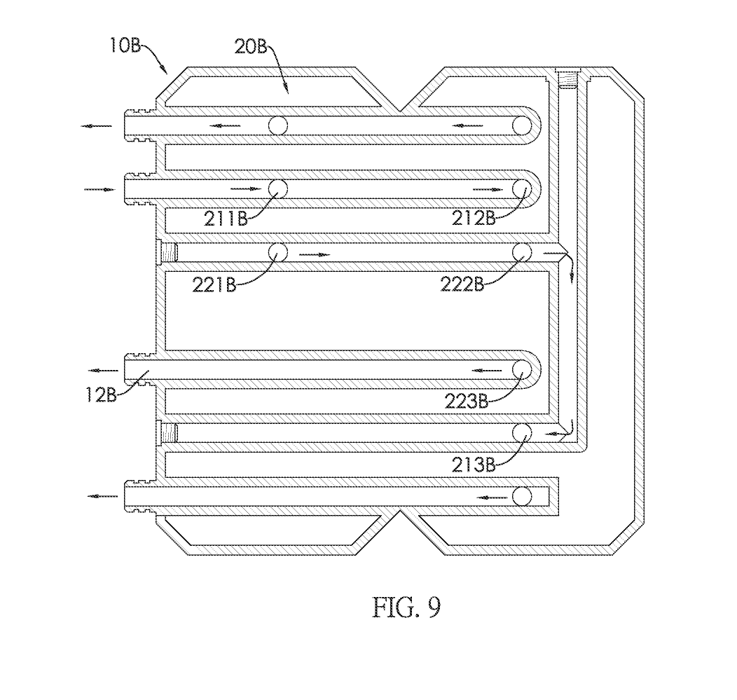

With reference to FIGS. 8 and 9, a third embodiment of a water gathering cover in accordance with the present invention is similar to the first embodiment as mentioned above. However, the third embodiment has only three hole sets 20B. Besides, the first and second hole sets 20B are in parallel connection, and the combination of the first and second hole sets 20B is in series connection with the third hole set 20B. The water flows in the first and second filter cartridges from the two inlets 211B, 212B respectively. Then the water flows out and back to the water gathering element 10B from the two purifying outlets 221B, 222B respectively. The water in the water gathering element 10B is gathered and moves to the third hole set 20B. The water flows in and out of the third filter cartridge from the inlet 213B and the purifying outlet 223B of the third hole set 20B respectively. Finally the water flows out of the water gathering element 10B from the main purifying outlet 12B, and the water that flows out is purified for two times. Because part of the water becomes waste water and flows out of the water gathering element 10B, the amount of water becomes less after each round of purification. As a result, one filter cartridge alone (the third filter cartridge) can suffice to purify the water from two filter cartridges (the first and second filter cartridges). The third embodiment can reach the same goal of reduced components and simplified assembling.

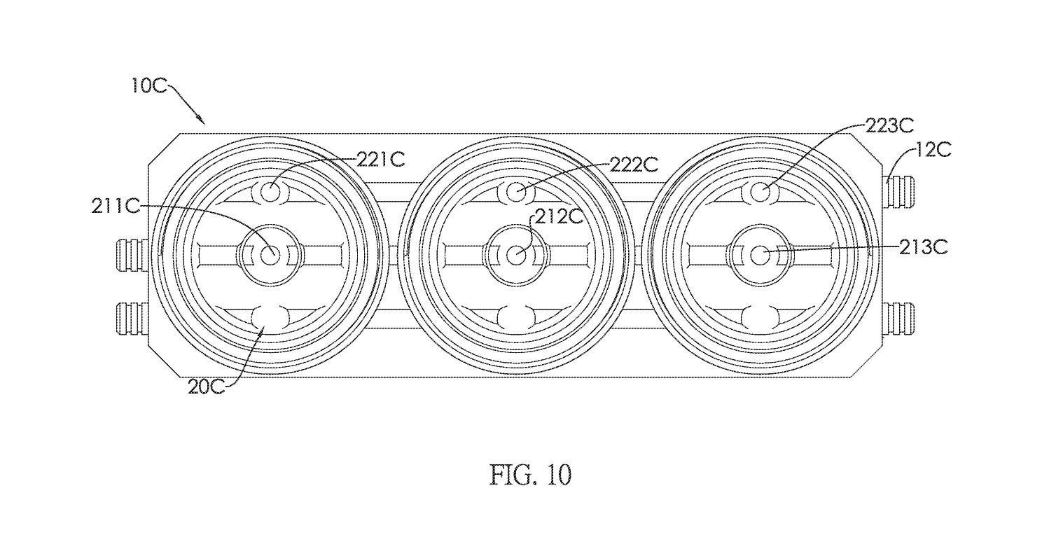

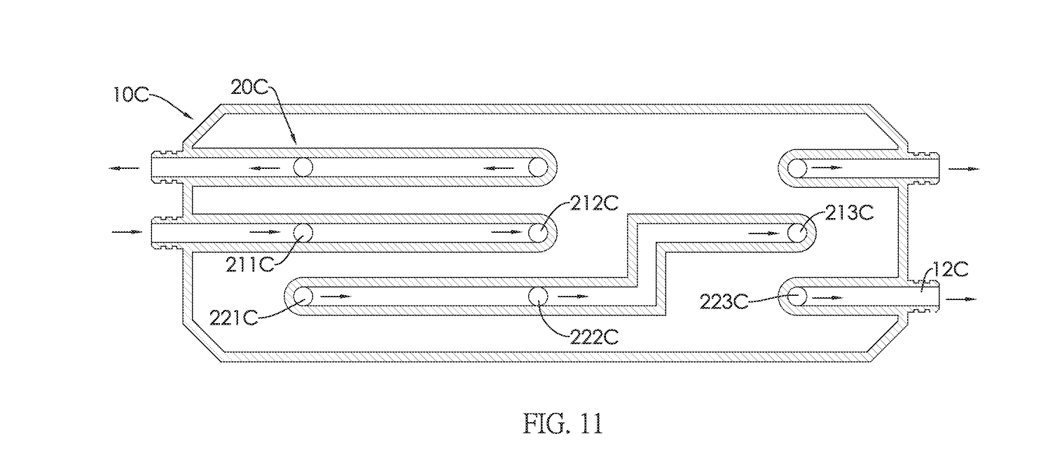

With reference to FIGS. 10 and 11, a fourth embodiment of a water gathering cover in accordance with the present invention is similar to the third embodiment as described above. However, in the fourth embodiment, the three hole sets 20C are arranged linearly at intervals. The water enters the first and second filter cartridges from the two inlets 211C, 212C respectively. Then the water that flows out and back to the water gathering element 10C from the two purifying outlets 221C, 222C respectively. The water in the water gathering element 10C is gathered and moved to the third hole set 20C. The water flows in and out of the third filter cartridge from the inlet 213C and the purifying outlet 223C of the third hole set 20C respectively. Finally the water flows out of the water gathering element 10C from the main purifying outlet 12C, and the water that flows out is purified for two times. Because of the elongated shape, the fourth embodiment can be used in some particular space arrangement and can reach the same goal of reduced components and simplified assembling.

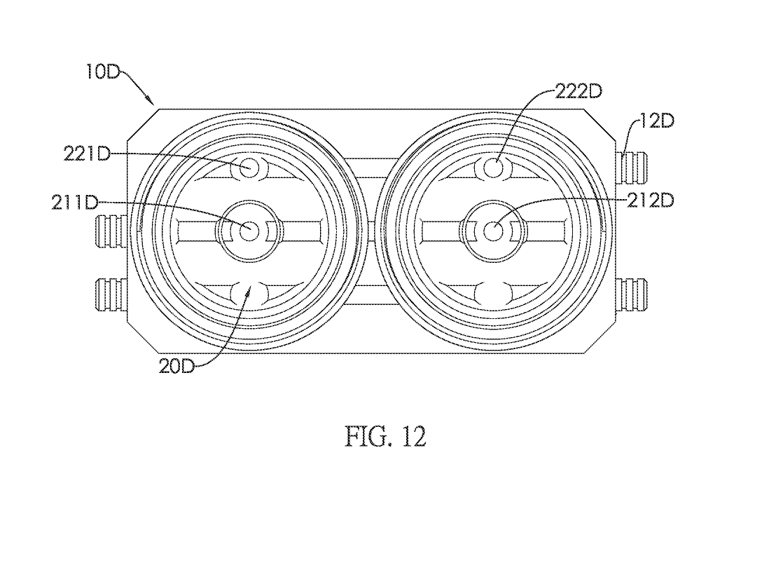

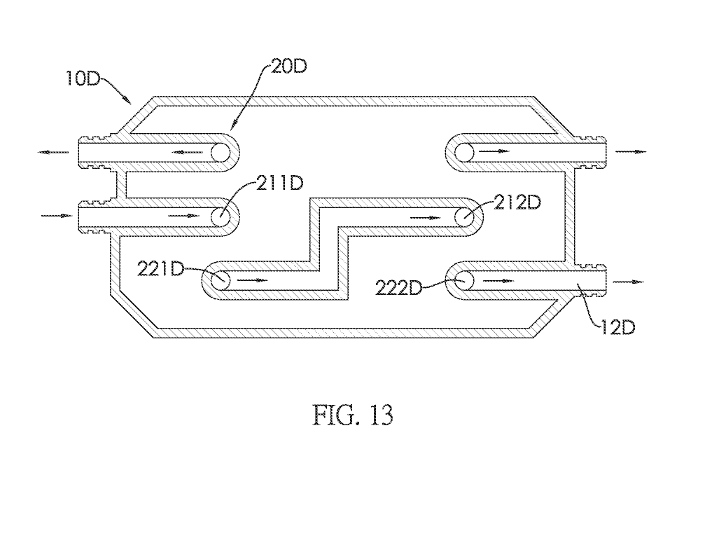

With reference to FIGS. 12 and 13, a fifth embodiment of a water gathering cover in accordance with the present invention is similar to the fourth embodiment as described above. However, the fifth embodiment has only two hole sets 20D, and the two hole sets 20D are in series connection. The water flows in and out of the first filter cartridge from the inlet 211D and the purifying outlet 221D of the first hole set 20D respectively. Then the water flows in and out of the second filter cartridge from the inlet 212D and the purifying outlet 222D of the second hole set 20D respectively. Finally the water flows out of the water gathering element 10D from the main purifying outlet 12D, and the water that flows out is purified for two times. The fifth embodiment can reach the same goal of reduced components and simplified assembling.

In another preferred embodiment, the number, arrangement, series connection or parallel connection of the hole sets and the overall shape of the water gathering cover can be changed and is not limited by the embodiments mentioned above.

In another preferred embodiment, the water gathering element also can have no main waste outlet, and each hole set also can have no waste outlet. This embodiment is for a filter cartridge that does not produce waste water.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A water gathering cover comprising:
a water gathering element having
a mounting surface;
a main inlet;
a main purifying outlet; and
multiple inner channels;
multiple hole sets formed on the mounting surface of the water gathering element, wherein two of the hole sets are respectively communicating with the main inlet and the main purifying outlet through one of the inner channels, the hole sets communicating with each other through the inner channels, and each hole set having
an inlet; and
a purifying outlet; and
multiple mounting sleeves formed on the mounting surface of the water gathering element, and each mounting sleeve surrounding one of the hole sets.

2. The water gathering cover as claimed in claim 1, wherein each mounting sleeve has an inner thread formed on an inside wall of the mounting sleeve.

3. The water gathering cover as claimed in claim 1, wherein
the water gathering element has at least one main waste outlet;
each hole set has a waste outlet communicating with one of the at least one main waste outlet through one of the inner channels.

4. The water gathering cover as claimed in claim 2, wherein
the water gathering element has at least one main waste outlet;
each hole set has a waste outlet communicating with one of the at least one main waste outlet through one of the inner channels.

5. The water gathering cover as claimed in claim 3 further comprising multiple separating sleeves, wherein each separating sleeve is formed on the mounting surface, surrounds one of the hole sets, is surrounded by a corresponding mounting sleeve and has a separating hole formed through the separating sleeve and communicating with the waste outlet of a corresponding hole set.

6. The water gathering cover as claimed in claim 4 further comprising multiple separating sleeves, wherein each separating sleeve is formed on the mounting surface, surrounds one of the hole sets, is surrounded by a corresponding mounting sleeve and has a separating hole formed through the separating sleeve and communicating with the waste outlet of a corresponding hole set.

7. The water gathering cover as claimed in claim 1, wherein the number of the hole sets is two.

8. The water gathering cover as claimed in claim 7, wherein the two hole sets are in series connection.

9. The water gathering cover as claimed in claim 1, wherein the number of the hole sets is three.

10. The water gathering cover as claimed in claim 9, wherein the three hole sets are a first hole set, a second hole set and a third hole set respectively, the first hole set and the second hole set are in parallel connection, and the combination of the first hole set and the second hole set is in series connection with the third hole set.

11. The water gathering cover as claimed in claim 9, wherein the three hole sets are arranged linearly at intervals.

12. The water gathering cover as claimed in claim 10, wherein the three hole sets are arranged linearly at intervals.

13. The water gathering cover as claimed in claim 1, wherein the number of the hole sets is four.

14. The water gathering cover as claimed in claim 13, wherein the four hole sets are a first hole set, a second hole set, a third hole set and a fourth hole set respectively, the first hole set and the second hole set are in parallel connection, the third hole set and the fourth hole set are in parallel connection, and the combination of the first hole set and the second hole set is in series connection with the combination of the third hole set and the fourth hole set.

15. The water gathering cover as claimed in claim 13, wherein the four hole sets are in series connection.

16. The water gathering cover as claimed in claim 13, wherein the four hole sets are arranged in a rectangle.

17. The water gathering cover as claimed in claim 14, wherein the four hole sets are arranged in a rectangle.

18. The water gathering cover as claimed in claim 15, wherein the four hole sets are arranged in a rectangle.
